(19) United States
(12) Patent Application Publication
(10) Pub. No.: US 2011/0207650 A1
(43) Pub. Date: Aug. 25, 2011

(54) ANTI-FOAMING COMPOSITIONS

(75) Inventor: Holger Rautschek, Nuenchritz (DE)

(73) Assignee: WACKER CHEMIE AG, Munich (DE)

(21) Appl. No.: 12/680,145

(22) PCT Filed: Sep. 9, 2008
(86) PCT No.: PCT/EP08/61926

§ 371 Date: Mar. 25, 2010

(30) Foreign Application Priority Data
Oct. 2, 2007 (DE) 10 2007 047 211.2

(51) Int. Cl. C11D 3/60; C09K 3/00; C08K 5/5419

(52) U.S. Cl. 510/405; 252/182.3; 524/266

(57) ABSTRACT

Effective defoaming compositions contains specific polyoxyalkylene-substituted organopolysiloxanes and at least one additive which is a particulate filler or an organopolysiloxane resin.

The invention relates to compositions which have selected organosilicon compounds with defined polyether radicals bonded directly to the silicon, to methods for the preparation thereof and to the use thereof as anti-foaming agent.

In many liquid, in particular aqueous, systems which comprise surface-active compounds as desired or undesired constituents, foam formation can lead to problems if these systems are brought into greater or lesser intensive contact with gaseous substances, for example during the gassing of wastewaters, during the intensive stirring of liquids, during distillation, washing or dyeing processes or during bottling operations.

This foam can be controlled by mechanical means or by adding anti-foaming agents. Here, anti-foaming agents based on siloxane have proven particularly useful. Anti-foaming agents based on siloxanes are prepared for example in accordance with DE-B 15 19 987 by heating hydrophilic silica in polydimethylsiloxanes.

Anti-foaming agents based on polydimethylsiloxanes have the disadvantage that polydimethylsiloxanes are not very compatible with most surfactant systems e.g. wetting agents or liquid detergents and have a tendency towards deposition, which is highly undesired.

Consequently, polyether siloxanes, optionally in mixtures with polypropylene glycol, have already been used therein for a long time as anti-foaming agents where good compatibility is required e.g. corresponding to DE-B 22 22 998. The polyether siloxanes have 6-420 polydimethylsiloxane units and 3-30 siloxane units which carry a polyether group.

Besides silica, small amounts of polydimethylsiloxane and MQ resin may also be present. In this respect, reference may be made for example to DE-C 22 33 817.

Since the effectiveness is often inadequate, combinations of polyether siloxanes with relatively large amounts of polydimethylsiloxanes are also used, as described e.g. in EP-A 341952. However, these anti-foaming formulations are not suitable for use in storage-stable aqueous surfactant systems.

The invention provides compositions comprising (A) at least one polymeric organosilicon compound consisting of units of the formula

Rₐ (R¹O)_{b}R² _{c}SiO_{(4-a-b-c)/2} (I)

in which
R may be identical or different and is hydrogen atom, a monovalent, optionally substituted, SiC-bonded hydro-carbon radical,
R¹ may be identical or different and is a hydrogen atom or a monovalent, optionally substituted hydrocarbon radical,
R² is a radical of the formula

—Z—O—(R⁵O)ₖ—A (II) ,

Z is a divalent, optionally substituted hydrocarbon radical,

R⁵ may be identical or different and is a divalent, optionally substituted hydrocarbon radical,
k is an integer from 1 to 200,
A is hydrogen atom or monovalent organic radical,
a is 0, 1, 2 or 3,
b is 0, 1, 2 or 3 and
c is 0, 1 or 2,
with the proviso that the sum a+b+c≦3, in at least 50% of all of the units of the formulae (I) the sum a+b+c is 2, the organosilicon compound consists of 150 to 1500 units of the formula (I) and in at least units, preferably at least 15 units, particularly preferably at least 20 units, of the organosilicon compound c is different from 0,
and
(B) at least one additive selected from
(B1) filler particles and/or
(B2) organopolysiloxane resin of units of the formula

R³ₑ(R⁴O)_{f}SiO_{(4-e-f)/2} (IV) ,

in which
R³ may be identical or different and is hydrogen atom or a monovalent, optionally substituted, SiC-bonded hydro-carbon radical,
R⁴ may be identical or different and is a hydrogen atom or a monovalent, optionally substituted hydrocarbon radical,
e is 0, 1, 2 or 3 and
f is 0, 1, 2 or 3,
with the proviso that the sum e+f≦3 and in less than 50% of all of the units of the formula (IV) in the organopolysiloxane resin the sum e+f is 2.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radicals; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; alkenyl radicals, such as the vinyl, 1-propenyl and the 2-propenyl radical; aryl radicals, such as the phenyl, naphthyl, anthryl and phenanthryl radical; alkaryl radicals, such as o-, m-, p-tolyl radicals; xylyl radicals and ethylphenyl radicals; and aralkyl radicals, such as the benzyl radical, the α-and the β-phenylethyl radical.

Examples of substituted radicals R are hydrocarbon radicals substituted by organosilyl groups, such as, for example, the trimethylsilylethylene radical, and also hydrocarbon radicals substituted by organo-siloxanyl groups, such as, for example, a radical of the formula

—CH₂CH_{2—Si(CH}₃)₂—O)₁₀₋₁₀₀₀—Si(CH₃)₂—CH=CH₂.

Preferably, the radical R does not have the meaning of hydrogen atom. Preferably, the total amount of units of the formula (I) in which R is hydrogen atom is less than 1.0%, in particular less than 0.2%.

Preferably, the radical R is hydrocarbon radicals having 1 to 18 carbon atoms and optionally substituted by organosilyl groups or by organosiloxanyl groups, particularly preferably linear alkyl radicals having 1 to 18 carbon atoms or aromatic radicals having 6 to 9 carbon atoms, particularly preferably methyl, n-hexyl, n-heptyl, n-octyl, n-dodecyl, phenyl and ethylphenyl radicals, in particular the methyl radical.

Preferably, the radical R¹ is hydrogen atom or optionally substituted hydrocarbon radicals having 1 to 30 carbon atoms, particularly preferably hydrogen atom or hydrocarbon radicals having 1 to 4 carbon atoms, in particular methyl or ethyl radicals.

Preferably, a is 1, 2 or 3.

Preferably, b is 0 or 1, particularly preferably 0.

Preferably, c is 0 or 1.

Examples of radical Z are —CH₂—CH₂—, —CH₂—CH(CH₃)—, —CH₂—CH₂—CH₂—, —CH₂—CH(CH₃)—CH₂—, —CH₂—CH₂—C₆H₄— and —CH₂—CH(CH₃)—C₆H₄—.

Preferably, radical Z is hydrocarbon radicals having 1 to 10 carbon atoms, where —CH₂—CH₂—CH₂— is particularly preferred.

Examples of radical A are the radicals stated above for radical R, and also acyl radicals, such as acetyl radicals.

Preferably, the radical A is hydrogen atom, hydrocarbon radicals and acyl radicals, particularly preferably hydrogen atom, methyl radical, allyl radical, butyl radical and acetyl radical.

Examples of radical R⁵ are —CH₂—CH₂—, —CH₂—CH(CH₃)—, —CH₂—CH₂—CH₂—, —CH₂—CH(CH₃)—CH₂— and —CH₂—CH(CH₂—CH₃)—.

Preferably, radical R⁵ is —CH₂—CH₂— or —CH₂—CH(CH₃)—.

Preferably, the radical R² is radicals of the formula

—(CH₂)ₓ—O—(C₂H₄O) ₘ—(C₃H₆O)ₙ—(C₄H₈O)ₒ—A (V)

where
x is an integer from 1 to 10, preferably 2 to 6, particularly preferably 3,
m is 0 or an integer from 1 to 200,
n is 0 or an integer from 1 to 200,
o is 0 or an integer from 1 to 200 and
A has the aforementioned meaning,
with the proviso that the sum m+n+o is 1 to 200 and the units (C₂H₄O), (C₃H₆O) and (C₄H₈O) may be present in random distribution or else as blocks in the radical of the formula (V).

Preferably, m is 0 or an integer from 1 to 30.

Preferably, n is an integer from 5 to 50.

Preferably, o is 0.

The organosilicon compounds used as component (A) are preferably branched or linear organopolysiloxanes.

Preferably, the component (A) used according to the invention is substantially linear organopolysiloxanes of the formula

R²_{z}R_{3-z}Si—(O—SiR₂)ₓ(O—SiRR²)_{y}O—SiR_{3-z}R²_{z} (III)

where
z is identical or different and is 0 or 1,
x has a value from 100 to 1000,
y has a value from 10 to 100 and the radicals R and R²
in each case have one of the aforementioned meanings,
where the x units (O—SiR₂) and the y units (O—SiRR²) may
be in arbitrary distribution in the molecule.

Although not stated in formula (III), these organopoly-siloxanes can comprise up to 10 mol %, based on the sum of all of the siloxane units, of other siloxane units, such as ≡SiO_{1/2}, —SiO_{3/2} and SiO_{4/2} units.

The organopolysiloxanes given in formula (III) may also comprise branches which result from Si—C linkages, if at least one radical R has the meaning of hydrocarbon radical substituted by organosilyl groups or by organo-siloxanyl groups, as e.g. analogously to the polyether siloxanes described in EP-A 298 402 and in EP-A 1 076 073, which is considered to form part of the disclosure of the present invention. However, such branched compounds (A) are not preferred.

The organosilicon compounds (A) used in the compositions according to the invention have a viscosity of preferably 500 to 1 000 000 mPas, particularly preferably from 1000 to 100 000 mPas, in particular from 5000 to 50 000 mPas, in each case measured at 25° C.

The organosilicon compounds used according to the invention are standard commercial products and/or can be prepared by methods customary in silicon chemistry.

For example, the organosilicon compounds (A) can be prepared through addition of compounds of the formula

Z′—O—(R⁵O)ₖ—A′ (VI),

where
Z′ is a monovalent, optionally substituted hydrocarbon radical having at least one terminal aliphatic carbon-carbon multiple bond and A′ has a meaning stated for A, and R⁵ and k has one of the meanings stated above for them,
onto organosilicon compounds with Si-bonded hydrogen atoms. This addition reaction, which is also referred to as hydrosilylation, is known to the person skilled in the art and is catalyzed e.g. by platinum compounds, such as hexachloroplatinic acid dissolved in isopropanol. Here, secondary reactions may also result in Si-O-C linkages, particularly if A′ is hydrogen atom, and on the other hand, small amounts of Si—H groups may also remain in the product. Both are neither intended nor preferred, but cannot always be completely avoided.

If A′ has the meaning of monovalent, optionally substituted hydrocarbon radical with at least one terminal aliphatic carbon-carbon multiple bond, branches are formed. However, preference is given to using compounds of the formula (VI) in which the radical A′ contains no aliphatic carbon-carbon multiple bonds, and so no branches are formed during the reaction.

Usually, during the synthesis of the component (A) according to the invention by addition reaction, a molar excess of 5 to 50% of compound (VI), based on the amount of Si-bonded hydrogen, is used. The amounts of compound (VI) used in excess remain in the product.

The compositions according to the invention comprise additive (B) in amounts of preferably 0.1 to 30 parts by weight, particularly preferably 1 to 15 parts by weight, in each case based on 100 parts by weight of component (A).

The additive (B) used according to the invention may be exclusively component (B1), exclusively component (B2) or a mixture of components (B1) and (B2), with the latter being preferred.

Component (B1) is preferably pulverulent, preferably hydrophobic, fillers.

Component (B1) preferably has a BET surface area of from 20 to 1000 m²/g, particularly preferably from 50 to 400 m²/g.

Component (B1) preferably has a particle size of less than 10 μm, particularly preferably of from 10 nm to 5 μm.

Component (B1) preferably has an agglomerate size of less than 100 μm, particularly preferably of 1 to 20 μm.

Examples of component (B1) are silicon dioxide (silicas), titanium dioxide, aluminum oxide, metal soaps, quartz flour, PTFE powder, fatty acid amides e.g. ethylenebisstearamide, finely divided hydrophobic polyurethanes.

Preferably, as component (B1), silicon dioxide (silicas), titanium dioxide or aluminum oxide with a BET surface area of from 20 to 1000 m²/g, a particle size of less than 10 μm and an agglomerate size of less than 100 μm are used.

As component (B1), particular preference is given to silicas, in particular those with a BET surface area of from 50 to 800 m²/g. These silicas may be fumed or precipitated silicas. As component (B1), it is possible to use either pretreated silicas, i.e. commercially available hydrophobic silicas, or hydrophilic silicas. Examples of standard commercial hydrophobic silicas which can be used according to the invention are HDK® H2000, a fumed silica treated with hexamethyl-disilazanes and having a BET surface area of 140 m²/g (commercially available from Wacker Chemie AG, Germany) and a precipitated silica treated with polydimethyl-siloxane and having a BET surface area of 90 m²/g (commercially available under the name “Sipernat D10” from Degussa AG, Germany).

If hydrophobic silicas are to be used as component (B1), hydrophilic silicas can also be hydrophobicized in situ if this is advantageous e.g. for the desired effectiveness of the composition as anti-foaming agent. Methods for the hydrophobicization of silicas are widely known. The in situ hydrophobicization of the hydrophilic silica can take place here e.g. by heating for several hours at temperatures of from 100 to 200° C. the silica dispersed in component (A) or in a mixture of (A) and (B2). Here, the reaction can be supported through the addition of catalysts, such as KOH, and of hydrophobicizing agents, such as short-chain OH-terminated polydimethylsiloxanes, silanes or silazanes. This treatment is also possible when using standard commercial hydrophobic silicas and can contribute to the improvement in effectiveness.

A further option is the use of a combination of in situ hydrophobicized silicas with standard commercial hydro-phobic silicas.

Component (B2) optionally used according to the invention is preferably silicone resins of units of the formula (IV), in which in 0 to 30%, preferably in 0 to 5%, of the units in the resin the sum c+d is 2.

Examples of radicals R³ are the examples stated for radical R, these preferably being alkyl radicals having 1 to 4 carbon atoms or the phenyl radical, in particular the methyl radical.

Examples of radicals R⁴ are the examples given for radical R, these preferably being alkyl radicals having 1 to 4 carbon atoms, particularly preferably methyl or ethyl radicals, in particular ethyl radicals.

Component (B2) is particularly preferably organopoly-siloxane resins which consist essentially of R³₃SiO_{1/2} (M) and SiO_{4/2} (Q) units where R³ has the aforementioned meaning; these resins are also referred to as MQ resins. The molar ratio of M to Q units is preferably in the range from 0.5 to 2.0, particularly preferably in the range from 0.6 to 1.0. Moreover, these silicone resins can contain up to 10% by weight of free hydroxy or alkoxy groups. R³ is here preferably methyl radical.

At 25° C., these organopolysiloxane resins (B2) preferably have a viscosity greater than 1000 mPas or are solids. The weight-average molecular weight (based on a polystyrene standard), determined by gel permeation chromatography, of these resins is preferably 200 to 200 000 g/mol, in particular 1000 to 20 000 g/mol.

Components (B2) are standard commercial products and/or can be prepared by methods customary in silicon chemistry, e.g. in accordance with “Parsonage, J. R.; Kendrick, D. A. (Science of Materials and Polymers Group, University of Greenwich, London, UK SE18 6PF) Spec. Publ.—R. Soc. Chem. 166, 98-106, 1995”, U.S. Pat. No. 2,676,182 or EP-A 927 733.

If the additive (B) used according to the invention is a mixture of components (B1) and (B2), the weight ratio of (B1) to (B2) in the mixture is preferably 0.01 to 50, particularly preferably 0.1 to 7.

The anti-foaming formulations according to the invention can comprise, as further component, organo-polysiloxanes (C) which consist exclusively of units of the formula (I) where c is 0, in particular polydimethylsiloxanes.

Examples of component (C) optionally used according to the invention are in principle all organosilicon compounds which are different to component (A) or component (B2), such as e.g. methylpolysiloxanes, such as for example polydimethylsiloxanes with viscosities of from 100 to 1 000 000 mPa·s at 25° C. These poly-dimethylsiloxanes may be branched e.g. as a result of the incorporation of R′SiO_{3/2} units where R′ has a meaning given for radical R or of SiO_{4/2} units up to at most 5% of all units. These branched or crosslinked-on siloxanes then have viscoelastic properties.

If the compositions according to the invention comprise component (C), the amounts are preferably 0.2 to 50 parts by weight, particularly preferably 1 to 10 parts by weight, in each case based on 100 parts by weight of component (A).

In one preferred embodiment, the compositions according to the invention comprise no component (C), in particular no polydimethylsiloxanes.

Components (C) are standard commercial products and/or can be prepared by methods customary in silicon chemistry.

Apart from components (A), (B) and optionally (C), the compositions according to the invention can comprise all further substances as have also hitherto been used in anti-foaming formulations, such as e.g. organic compounds (D).

The optionally used component (D) is preferably organic compounds with a boiling point greater than 100° C., at the pressure of the ambient atmosphere, thus at 900 to 1100 hPa, in particular compounds which can be distilled not undecomposed, in particular those selected from mineral oils, native oils, isoparaffins, polyisobutylenes, residues from the oxo alcohol synthesis, esters of low molecular weight synthetic carboxylic acids, fatty acid esters, such as e.g. octyl stearate, dodecyl palmitate, fatty alcohols, ethers of low molecular weight alcohols, phthalates, polyethylene glycols, polypropylene glycols, polyethylene glycol-polypropylene glycol copolymers, esters of phosphoric acid and waxes.

The optionally used component (D) is particularly preferably glycols, glycol ethers and polyglycols such as polyethylene glycols, polypropylene glycols and polyethylene glycol-polypropylene glycol copolymers, e.g. the compound (VI) used in excess in the preparation of component (A).

The compositions according to the invention comprise organic compound (D) in amounts of preferably 0 to 1000 parts by weight, particularly preferably 0 to 100 parts by weight, in each case based on 100 parts by weight of the total weight of components (A), (B) and optionally (C).

The compositions according to the invention preferably comprise component (D).

Preferably, the compositions according to the invention are those which comprise

(A) at least one organosilicon compound of the formula (III),
(B) at least one additive selected from
(B1) filler particles and/or
(B2) organopolysiloxane resin from units of the formula (IV),
optionally
(C) organosilicon compounds containing units of the formula (I) where c is 0 and
optionally
(D) one or more organic compounds.

The compositions according to the invention are particularly preferably those which consist of

(A) 100 parts by weight of an organosilicon compound of the formula (III),
(B) 0.1 to 30 parts by weight of an additive selected from
(B1) filler particles and/or
(B2) organopolysiloxane resin of units of the formula (IV),
optionally
(C) organosilicon compounds comprising units of the formula (I) where c is 0 and
optionally
(D) one or more organic compounds.

In particular, the compositions according to the invention are those which consist of

(A) 100 parts by weight of an organosilicon compound of the formula (III),
(B1) 1 to 10 parts by weight of filler particles and
(B2) 1 to 10 parts by weight of organopolysiloxane resin of units of the formula (IV),
and
(D) 0 to 1000 parts by weight of one or more organic compounds.

The compositions according to the invention are preferably viscous clear to opaque colorless to brownish liquids.

The compositions according to the invention have a viscosity of preferably 100 to 2 000 000 mPas, particularly preferably from 500 to 50 000 mPas, in particular from 1000 to 20 000 mPas, in each case at 25° C.

The compositions according to the invention may be solutions, dispersions or powders.

The preparation of the compositions according to the invention can take place by known methods, such as e.g. by mixing all components, such as e.g. with the application of high shear forces in colloid mills, dissolvers or rotor-stator homogenizers. Here, the mixing operation can take place at reduced pressure in order to prevent the incorporation of air, which is present e.g. in highly disperse fillers. If required, the in situ hydrophobicization of the fillers can then take place.

If the compositions according to the invention are emulsions, it is possible to use all emulsifiers which are known to the person skilled in the art for producing silicone emulsions, such as e.g. anionic, cationic or nonionogenic emulsifiers. Preference is given to using emulsifier mixtures, where at least one nonionogenic emulsifier, such as, for example, sorbitan fatty acid esters, ethoxylated sorbitan fatty acid esters, ethoxylated fatty acids, ethoxylated linear or branched alcohols having 10 to 20 carbon atoms and/or glycerol esters, should be present. Furthermore, compounds known as thickeners, such as polyacrylic acid, polyacrylates, cellulose ethers such as carboxy-methylcellulose and hydroxyethylcellulose, natural gums such as xanthan gum and polyurethanes, and also preservative and other additives that are customary and known to the person skilled in the art can be added.

The continuous phase of the emulsions according to the invention is preferably water. However, it is also possible to prepare compositions according to the invention in the form of emulsions in which the continuous phase is formed by the components (A), (B) and optionally (C) or is formed by component (D). These may also be multiple emulsions.

Methods for producing silicone emulsions are known. Usually, the preparation takes place by simply stirring all of the constituents and, if appropriate, subsequently homogenizing using jet dispersers, rotor-stator homogenizers, colloid mills or high-pressure homogenizers.

If the composition according to the invention is emulsions, oil-in-water emulsions comprising 5 to 50% by weight of components (A) to (D), 1 to 20% by weight of emulsifiers and thickeners and 30 to 94% by weight of water are preferred.

The compositions according to the invention can also be formulated as free-flowing powders. These are preferred e.g. when used in pulverulent detergents. The preparation of these powders starting from the mixture of components (A), (B), optionally (C) and optionally (D) takes place by methods known to the person skilled in the art, such as spray-drying or build-up granulation and with additives known to the person skilled in the art.

The powders according to the invention preferably comprise 2 to 20% by weight of components (A) to (D). The carriers used are e.g. zeolites, sodium sulfate, cellulose derivatives, urea and sugars. Further constituents of the powders according to the invention may be e.g. waxes or organic polymers as are described e.g. in EP-A 887097 and EP-A 1060778.

The present invention further provides liquid wetting, washing and cleaning agents comprising the compositions according to the invention.

The compositions according to the invention can be used wherever compositions based on organosilicon compounds have hitherto also been used. In particular, they can be used as anti-foaming agents.

The present invention further provides a method for the defoaming and/or foam prevention of media, characterized in that the composition according to the invention is mixed with the medium.

The addition of the composition according to the invention to the foaming media can take place directly, in suitable solvents, such as toluene, xylene, methyl ethyl ketone or t-butanol, in dissolved form, as powder or as emulsion. The amount required to achieve the desired anti-foaming effect is governed e.g. by the nature of the medium, the temperature and the turbulence which arises.

Preferably, the compositions according to the invention are mixed directly with concentrated liquid surfactant formulations.

The compositions according to the invention are preferably added to the ready-to-use foaming medium in amounts of from 0.1 ppm by weight to 1% by weight, in particular in amounts of from 1 to 100 ppm by weight. In concentrated surfactant formulations, the compositions according to the invention may be present to 0.1 to 20% by weight, in particular to 0.5 to 5% by weight.

The method according to the invention is carried out at temperatures of preferably −10 to +150° C., particularly preferably 5 to 100° C., and the pressure of the ambient atmosphere, thus about 900 to 1100 hPa. The method according to the invention can also be carried out at higher or lower pressures, such as for example at 3000 to 4000 hPa or 1 to 10 hPa.

The anti-foaming compositions according to the invention can be used wherever troublesome foam is to be suppressed. This is the case e.g. in nonaqueous systems such as during the distillation of tar or the processing of petroleum. In particular, the anti-foaming compositions according to the invention are suitable for controlling foam in aqueous surfactant systems, use in detergents and cleaners, controlling foam in wastewater plants, in textile dyeing processes, in the scrubbing of natural gas, in polymer dispersions, and for the defoaming of aqueous media which are produced during pulp manufacture.

The compositions according to the invention have the advantage that they can be handled easily as anti-foaming agents, are miscible with concentrated surfactant formulations, and that they are characterized by a high, long-lasting effectiveness in highly diverse media for small added amounts. This is both economically and also ecologically extraordinarily advantageous.

The method according to the invention has the advantage that it is easy to carry out and is very economical.

In the examples below, all of the data refer to parts and percentages, unless stated otherwise, based on the weight. Unless stated otherwise, the examples below are carried out at a pressure of the ambient atmosphere, thus at about 1000 hPa, and at room temperature, thus about 20° C. or a temperature that is established upon combining the reactants at room temperature without additional heating or cooling. All of the viscosity data stated in the examples are intended to refer to a temperature of 25° C.

Compatibility Tests

To test the anti-foaming effectiveness, in each case 2% of the anti-foaming formulations are added to various liquid surfactant formulations. After 14 days, the compatibility is assessed visually on the following scale: +=compatible, ∘=slight depositions, −=incompatible.

Products which were compatible or exhibited only slight depositions were tested for their effectiveness.

Anti-Foaming Effectiveness Tests

To test the effectiveness, a 0.1% strength by weight solution of the anti-foaming agent-containing surfactant formulation was circulated in a heated beaker such that the circulated surfactant solution dropped onto the surface of the surfactant solution from a height of 10 cm. The foam increase was continually observed over a period of 60 min. The temperature and circulation velocity can be found in the respective individual examples.

Surfactant Formulations

Formulation 1: An aqueous formulation comprising 10% by weight of dodecylbenzenesulfonic acid (available under the name “Marlon AS3-Säure” from Sasol Germany GmbH, Germany), 7% by weight of triethanolamine and 10% by weight of ethoxylated tridecyl alcohol with 10 ethylene glycol units (available under the name “Lutensol TO 109” from BASF AG, Germany).

Formulation 2: A mixture of fatty alcohol ethoxylates with a density of 1.0108 and an active ingredient content of 40% by weight.

Formulation 3: A mixture of ionic surfactants based on fatty acid alkanolamides with a density of 1.0059 and an active ingredient content of 36% by weight.

Formulation 4: Mixture of alkanesulfonates and fatty alcohol ethoxylates with a density of 1.0131 and an active ingredient content of 18% by weight.

The polymeric organosilicon compounds used as component A in the examples and comparative examples were prepared by the addition reaction of aliphatic, terminally unsaturated ethers E of the formula

CH=CH—CH₂—O—(C₂H₄O)ₘ—(C₃H₆O)ₙ—A

or in examples 4, 5 and 6, mixtures thereof, onto Si-bonded organosilicon compounds having hydrogen, the ethers or ether mixtures E in each case being used in excess.

The structure of the organosilicon compounds A1-A9 and AV1-AV4 produced as a result can be found in table 1 below and correspond to the following formula

(CH₃)₃Si—(O—Si(CH₃)₂)ₓ(O—SiCH₃R²)_{y}O—Si(CH₃)₃,

where

R²=—(CH₂)₃—O—(C₂H₄O)ₘ—(C₃H₆O)ₙ—A.

TABLE 1

| | | | | Cloud point | Vis- |
|---|---|---|---|---|---|
| | | | | in ° C. | cosity |
| | x | y | R² | (EN1890) | in mPas |
| A1 | 285 | 43 | m = 20, n = 20, A = H | 43.5 | 8280 |
| A2 | 173 | 17 | m = 20, n = 20, A = H | 44.0 | 8390 |
| A3 | 358 | 38 | m = 20, n = 20, A = H | 44.5 | 22700 |
| A4 | 256 | 24 | 8 (m = 0, n = 30, A = H) | 38.0 | 29300 |
| | | | 16 (m = 20, n = 20, A = H) | | |
| A5 | 256 | 24 | 12 (m = 0, n = 30, A = H) | 34.0 | 20600 |
| | | | 12 (m = 20, n = 20, A = H) | | |
| A6 | 256 | 24 | 16 (m = 0, n = 30, A = H) | 35.0 | 16900 |
| | | | 8 (m = 20, n = 20, A = H) | | |
| A7 | 377 | 21 | m = 10, n = 0, A = H | <30 | 52200 |
| A8 | 930 | 50 | m = 6, n = 0, A = C(O)CH₃ | <30 | 126000 |
| A9 | 930 | 50 | m = 20, n = 20, A = CH₃ | <30 | 150000 |
| AV1 | 110 | 11 | m = 20, n = 20, A = H | 44.0 | 4190 |
| AV2 | 100 | 41 | m = 20, n = 20, A = H | 42.0 | 6950 |
| AV3 | 40 | 6 | m = 0, n = 30, A = H | <30 | 713 |
| AV4 | 70 | 5 | m = 25, n = 25, A = H | 42.0 | 825 |

The components A used in the examples below are in each case mixtures A1*-A9* and AV1*-AV4* of 85% by weight of the organosilicon compounds A1-A9 and AV1-AV4 and 15% by weight of the ethers and ether mixtures used in each case in excess for their preparation.

As components B, the following substances were used:

B11: A fumed hydrophilic silica with a BET surface area of 400 m²/g available under the trade name HDK® T40 from Wacker Chemie AG, Munich, Germany.

B12: A fumed hydrophobicized silica with a BET surface area of 150 m²/g and a carbon content of 0.8% available under the trade name HDK® H15 from Wacker Chemie AG, Munich, Germany.

B13: A fumed hydrophobicized silica with a BET surface area of 200 m²/g and a carbon content of 2.8% available under the trade name HDK® H2000 from Wacker Chemie AG, Munich, Germany.

B21: A silicone resin solid at room temperature and consisting of (in accordance with ²⁹Si-NMR and IR analysis) 40 mol % CH SiO_{1/2} units, 50 mol % SiO_{4/2} units, 8 mol % C₂H₅OSiO_{3/2} units and 2 mol % HOSiO_{3/2} units with a weight-average molar mass of 7900 g/mol (based on polystyrene standard).

As component D, the following were used:

D1: A hydrocarbon mixture with a boiling range of 235-270° C. (commercially available under the name Exxsol D 100 S from Staub & Co Nuremburg, Germany)

D2: A polypropylene glycol with a viscosity of ca. 100 mPas (available under the name PPG 400 from F. B. Silbermann GmbH & Co KG, Gablingen, Germany).

### Examples 1 to 12 and Comparative Examples V1 to V5

The formulation for each example and comparative example is given in table 2. The percentages here refer in each case to the weight.

TABLE 2

| Example | Component A | Component B | Component D |
|---|---|---|---|
| 1 | 90% A1 | 5% B21 | 5% D1 |
| 2 | 85% A2* | 5% B12, 5% B21 | 5% D1 |
| 3 | 90% A3* | 5% B11, 5% B21 | — |
| 4 | 85% A3* | 5% B12, 5% B21 | 5% D1 |
| 5 | 90% A3* | 5% B21 | 5% D1 |
| 6 | 95% A3* | 5% B12 | — |
| 7 | 45% A4* | 2.5% B21 | 2.5% D1, 50% D2 |
| 8 | 42.5% A5* | 2.5% B13, 2.5% B21 | 2.5% D1, 50% D2 |
| 9 | 42.5% A6* | 2.5% B13, 2.5% B21 | 2.5% D1, 50% D2 |
| 10 | 45% A7* | 2.5% B21 | 52.5% D1 |
| 11 | 42.5% A8* | 2.5% B13, 2.5% B21 | 2.5% D1, 50% D2 |
| 12 | 42.5% A9* | 2.5% B13, 2.5% B21 | 2.5% D1, 50% D2 |
| V1 | 90% AV1* | 5% B11, 5% B21 | — |
| V2 | 95% AV2* | 5% B13 | — |
| V3 | 95% AV3* | 5% B13 | — |
| V4 | 90% AV3* | 5% B21 | 5% D1 |
| V5 | 42.5% AV4* | 2.5% B13 | 2.5% D1, 50% D2 |

The individual anti-foaming formulations were prepared by simply mixing all of the components using a dissolver disk. The formulations of example 3 and comparative example 1 (V1) were additionally heated at 110° C. in the presence of 1500 ppm of KOH for 4 h.

The anti-foaming effect of the formulations prepared in this way is tested by reference to surfactant formulations and the results are summarized in tables 3 to 5.

TABLE 3
Results of the test of the anti-foaming
agents in surfactant formulation 1

| | | Foam height after | Foam height after |
|---|---|---|---|
| | | 60 min at 50° C. | 60 min at 80° C. |
| Example | Compatibility | and 80 l/h | and 80 l/h |
| Without | + | 60 mm | 48 mm |
| 7 | + | 50 mm | 33 mm |
| 8 | + | 43 mm | 22 mm |
| 9 | + | 50 mm | 33 mm |
| V5 | + | 60 mm | 50 mm |

TABLE 4
Results of the test of the anti-foaming
agents in surfactant formulation 2

| | | Maximum foam height at |
|---|---|---|
| Example | Compatibility | 50° C. and 80 l/h |
| Without | + | 55 mm |
| 7 | + | 18 mm |
| 8 | ∘ | 15 mm |
| 9 | ∘ | 40 mm |
| 10 | + | 30 mm |
| 11 | ∘ | 18 mm |
| 12 | ∘ | 30 mm |
| V5 | ∘ | 54 mm |

TABLE 5
Results of the test of the anti-foaming
agents in surfactant formulation 3

| | | Maximum foam height at |
|---|---|---|
| Example | Compatibility | 50° C. and 80 l/h |
| Without | + | 55 mm |
| 7 | ∘ | 33 mm |
| 8 | ∘ | 45 mm |
| 9 | ∘ | 28 mm |
| V5 | ∘ | 53 mm |

TABLE 6
Results of the test of the anti-foaming
agents in surfactant formulation 4

| | | Maximum foam | | Maximum foam |
|---|---|---|---|---|
| | | height at 80° C. | | height at 80° C. |
| Example | Compatibility | and 100 1/h | | and 80 1/h |
| Without | + | >80 | mm | 78 mm |
| 1 | + | 50 | mm | — |
| 2 | + | 18 | mm | — |
| 3 | ∘ | 15 | mm | — |
| 4 | ∘ | 30 | mm | — |
| 5 | + | 18 | mm | — |
| 6 | ∘ | 38 | mm | — |
| 7 | + | — | | 30 mm |
| 8 | + | — | | 20 mm |
| 9 | ∘ | — | | 30 mm |
| 10 | + | — | | 33 mm |
| 12 | + | — | | 18 mm |
| V1 | ∘ | >80 | mm | — |
| V2 | + | >80 | mm | — |
| V3 | ∘ | >80 | mm | — |
| V4 | ∘ | >80 | mm | — |

| | | | |
|---|---|---|---|
| V5 | ∘ | — | 54 mm |

1.-10. (canceled)

11. A composition comprising
(A) at least one polymeric organosilicon compound consisting of units of the formula
Rₐ (R¹O)_{b}R² _{c}SiO_{(4-a-b-c)/2} (I)
in which
R are identical or different and are hydrogen or a monovalent, optionally substituted, SiC-bonded hydrocarbon radical,
R¹ are identical or different and are hydrogen or a monovalent, optionally substituted hydrocarbon radical,
R² is a radical of the formula
—Z—O—(R⁵O)ₖ—A (II),
Z is a divalent, optionally substituted hydrocarbon radical,
R⁵ are identical or different and are divalent, optionally substituted hydrocarbon radicals,
k is an integer from 1 to 200,
A is hydrogen or a monovalent organic radical,
a is 0, 1, 2 or 3,
b is 0, 1, 2 or 3 and
c is 0, 1 or 2,
with the proviso that the sum a+b+c≦3, in at least 50% of all of the units of the formulae (I) the sum a+b+c is 2, the organosilicon compound consists of 150 to 1500 units of the formula (I), and in at least 10 units of the organosilicon compound c is different from 0, and
(B) at least one additive (B1) or (B2)
(B1) filler particles and/or
(B2) organopolysiloxane resins comprising units of the formula
R³ₑ(R⁴O)_{f}SiO_{(4-e-f)/2} (IV) ,
in which
R³ are identical or different and are hydrogen or a monovalent, optionally substituted, SiC-bonded hydrocarbon radical,
R⁴ are identical or different and are hydrogen or a monovalent, optionally substituted hydrocarbon radical,
e is 0, 1,2 or 3 and
f is 0, 1, 2 or 3,
with the proviso that the sum e+f≦3 and in less than 50% of all of the units of the formula (IV) in the organopolysiloxane resin the sum e+f is 2.

12. The composition of claim 11, wherein the radical R² is a radical of the formula
—(CH₂)ₓ—O—(C₂H₄O) ₘ—(C₃H₆O)ₙ9—(C₄H₈O)ₒ—A (V)
where
x is an integer from 1 to 10,
m is 0 or an integer from 1 to 200,
n is 0 or an integer from 1 to 200,
o is 0 or an integer from 1 to 200,
with the proviso that the sum m+n+o is 1 to 200 and the units (C₂H₄O), (C₃H₆O) and (C₄H₈O) may be present in random distribution or else as blocks in the radical of the formula (V).

13. The composition of claim 11, wherein component (A) is a substantially linear organopolysiloxane of the formula
R²_{z}R_{3-z}Si—(O—SiR₂)ₓ(O—SiRR²)_{y}O—SiR_{3-z}R²_{z} (III)
where
z is identical or different and is 0 or 1,
x has a value from 100 to 1000,
y has a value from 5 to 100, where the x units (O—SiR₂) and the y units (O—SiRR²) may be in arbitrary distribution in the molecule.

14. The composition of claim 12, wherein component (A) is a substantially linear organopolysiloxane of the formula
R²_{z}R_{3-z}Si—(O—SiR₂)ₓ(O—SiRR²)_{y}O—SiR_{3-z}R²_{z} (III)
where
z is identical or different and is 0 or 1,
x has a value from 100 to 1000,
y has a value from 5 to 100, where the x units (0-SiR₂) and the y units (0-SiRR²) may be in arbitrary distribution in the molecule.

15. The composition of claim 11, wherein the compositions comprise additive (B) in amounts of from 0.1 to 30 parts by weight, based on 100 parts by weight of component (A).

16. The composition of claim 12, wherein the compositions comprise additive (B) in amounts of from 0.1 to 30 parts by weight, based on 100 parts by weight of component (A).

17. The composition of claim 13, wherein the compositions comprise additive (B) in amounts of from 0.1 to 30 parts by weight, based on 100 parts by weight of component (A).

18. The composition of claim 14, wherein the compositions comprise additive (B) in amounts of from 0.1 to 30 parts by weight, based on 100 parts by weight of component (A).

19. The composition of claim 11, wherein the composition contains no component (C).

20. The composition of claim 11, wherein the composition contains component (D).

21. The composition of claim 11, wherein the composition consists essentially of
(A) 100 parts by weight of at least one organosilicon compound of the formula (III),
(B) 0.1 to 30 parts by weight of at least one additive selected from the group consisting of
(B1) filler particles and
(B2) organopolysiloxane resin of units of the formula (IV),
(C) optionally organosilicon compound(s) comprising units of the formula (I) where c is 0 and optionally
(D) one or more organic compounds.

22. A liquid wetting, washing or cleaning agent comprising a composition of claim 11.

23. A method for defoaming or preventing foaming of liquid media, comprising mixing a composition of claim 11 with the media.

24. The method of claim 23, wherein the composition is added to the ready-to-use foaming medium in amounts of from 0.1 ppm by weight to 1% by weight based on the weight of the media.
